(19) United States
(12) Patent Application Publication
(10) Pub. No.: US 2007/0018421 A1
(43) Pub. Date: Jan. 25, 2007

(54) Foldable bicycle

(76) Inventor: Min-Chang Chen, Taichung Hsien (TW)

Correspondence Address: HARNESS, DICKEY & PIERCE, P.L.C., P.O. BOX 8910, RESTON, VA, 20195, US

(21) Appl. No.: 11/183,770

(22) Filed: Jul. 19, 2005

(51) Int. Cl. B62K 17/00

(52) U.S. Cl. 280/278

(57) ABSTRACT

A foldable bicycle includes front and rear frames pivotally connected to each other by a horizontal journal pin that is non-parallel to a rear wheel axle such that the rear frame is turnable between unfolded and folded positions. A bracing lever has a pivot end pivotally mounted on one of the front and rear frames, and a retaining end operable to turn between a retained position to be prevented from disengaging from the other one of the front and rear frames when the rear frame is in the unfolded position, and a releasing position to permit turning of the rear frame so as to fold the bicycle.

### BACKGROUND OF THE INVENTION

1. Field of the Invention

This invention relates to a foldable bicycle, more particularly to a foldable bicycle with front and rear frames which are foldable by turning relative to each other about a horizontal pivot axis.

2. Description of the Related Art

A conventional foldable bicycle is generally folded by turning a rear frame relative to a front frame about a horizontal pivot axis to bring a rear wheel into juxtaposition with a front wheel. Since the front and rear frames are in tandem in an unfolded position for use, the front wheel may interfere with the rear wheel during folding of the bicycle, which makes the folding operation inconvenient and time-consuming.

In a co-pending U.S. patent application Ser. No. 10/945,099, entitled “Foldable Bicycle,” filed by the applicant, there is disclosed a foldable bicycle which includes front and rear frames pivotally connected to each other by a pivot axis that is inclined relative to an extending axis of the front and rear frames such that, when folded to the folded position, the rear frame is spaced apart from the front frame so as to prevent the rear wheel on the rear frame from interfering with the front wheel on the front frame. Moreover, a bracing unit, which is in the form of a linkage mechanism, is operable to permit turning of the front and rear frames about the pivot axis. Moreover, such linkage mechanism is relatively complicated in construction.

### SUMMARY OF THE INVENTION

The object of the present invention is to provide a foldable bicycle which has a simplified construction.

According to this invention, the foldable bicycle includes front and rear frames respectively having front and rear shank segments which extend towards each other along a longitudinal axis in an unfolded position, and which respectively terminate at rearward and forward abutting walls that respectively have upper edges extending in a transverse direction relative to the longitudinal axis. Front and rear wheel axles are respectively mounted to the front and rear frames, and are adapted for mounting of front and rear wheels thereon. The rear wheel axle extends along a rear wheel axis which is oriented in the transverse direction. A journal pin is disposed to interconnect the front and rear frames, is disposed below the upper edges of the rearward and forward abutting walls, and extends along a pivot axis that is non-parallel to the rear wheel axis such that the rear shank segment is turnable relative to the front shank segment about the pivot axis between the unfolded position, where the rearward and forward abutting walls abut against each other, and a folded position, where the upper edge of the forward abutting wall is remote from the upper edge of the rearward abutting wall, and where the front and rear wheels are adapted to be juxtaposed in the transverse direction. A bracing lever has a pivot end which is pivotally mounted on one of the front and rear frames about a rotating axis parallel to the rear wheel axis, and a retaining end which is configured to be operable to turn about the rotating axis between a retained position, where the retaining end is prevented from disengaging from the other one of the front and rear frames when the rear shank segment is in the unfolded position so as to prevent turning of the rear shank segment relative to the front shank segment about the pivot axis, and a releasing position, where the retaining end is disengaged from the other one of the front and rear frames so as to permit turning of the rear shank segment relative to the front shank segment about the pivot axis.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic side view of the first preferred embodiment of a foldable bicycle according to this invention when unfolded;

FIG. 2 is a schematic bottom view of the first preferred embodiment;

FIG. 3 is a fragmentary perspective view of a bracing device of the first preferred embodiment in a retained position;

FIG. 4 is a fragmentary perspective view of the bracing device of the first preferred embodiment in a releasing position;

FIG. 5 is a schematic side view showing how the first preferred embodiment is folded;

FIG. 6 is a schematic side view of the first preferred embodiment when folded;

FIG. 7 is a perspective view of the first preferred embodiment when folded;

FIG. 8 is a schematic side view of the second preferred embodiment of a foldable bicycle according to this invention when unfolded; and

FIG. 9 is a schematic side view of the second preferred embodiment when folded.

### DETAILED DESCRIPTION OF THE PREFERRED EMBODIMENTS

Before the present invention is described in greater detail, it should be noted that same reference numerals have been used to denote like elements throughout the specification.

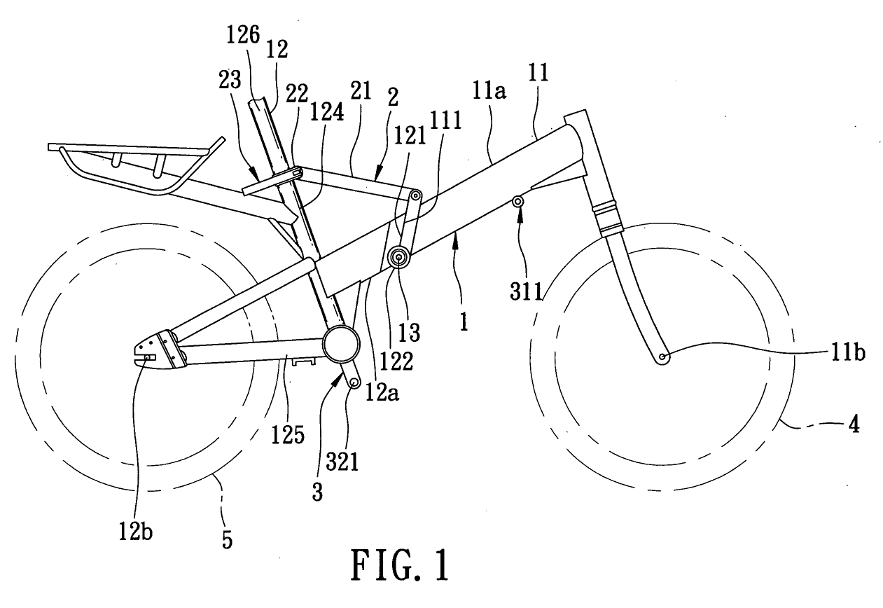

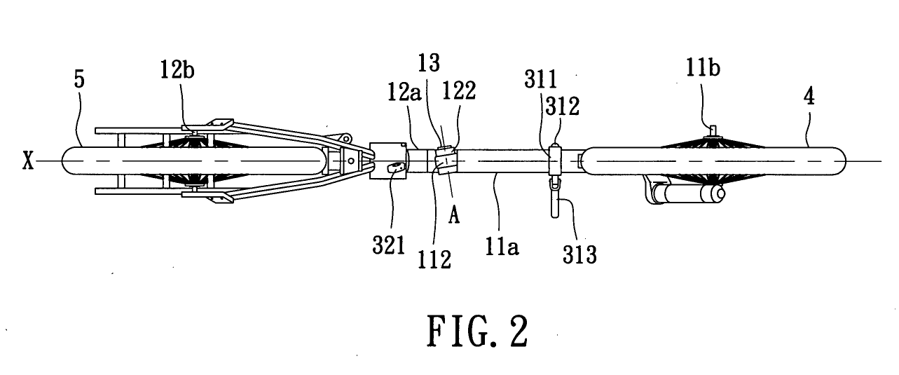

Referring to FIGS. 1 and 2, the preferred embodiment of a foldable bicycle according to the present invention is shown to comprise a bicycle frame unit 1, a bracing device 2, and a positioning device 3.

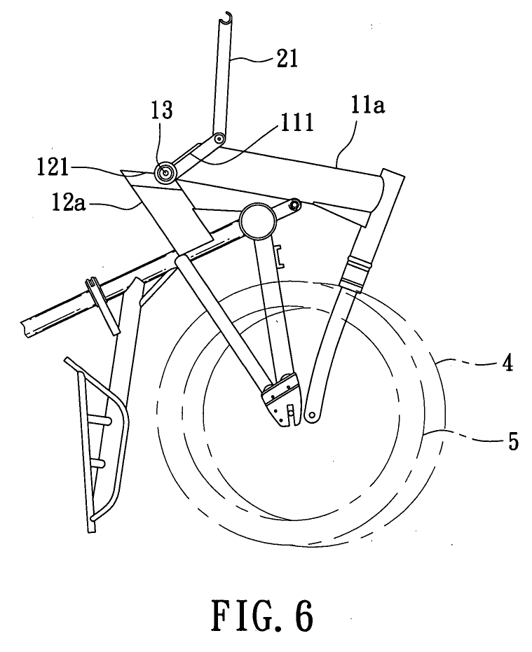

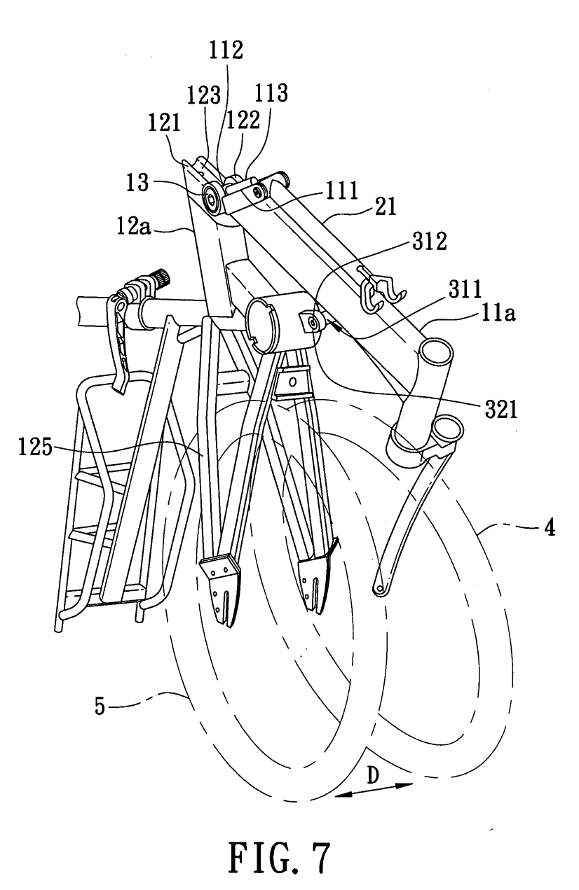

The bicycle frame unit 1 includes front and rear frames 11, 12 respectively having front and rear shank segments 11a, 12a which extend towards each other along a longitudinal axis (X) in an unfolded position as shown in FIG. 1, and which respectively terminate at rearward and forward abutting walls 111, 121 that respectively have upper edges extending in a transverse direction relative to the longitudinal axis (X). Front and rear wheel axles 11b, 12b are respectively mounted to the front and rear frames 11, 12, and are adapted for mounting of front and rear wheels 4, 5. The rear wheel axle 12b extends along a rear wheel axis which is oriented in the transverse direction. The rearward and forward abutting walls 111, 121 share an inclined plane that is inclined relative to the longitudinal axis (X) when the rear shank segment 12a is in the unfolded position. The rear shank segment 12a has a pair of lug portions 122 which are disposed below the upper edge and which are spaced apart from each other along a pivot axis (A) that extends along the inclined plane and that is non-parallel to the rear wheel axis. The front shank segment 11a has a journal 112 which is disposed between the lug portions 122. A journal pin 13 extends through the lug portions 122 and the journal 112 along the pivot axis (A). Thus, the rear shank segment 12a is turnable relative to the front shank segment 11a about the pivot axis (A) between the unfolded position, where the rearward and forward abutting walls 111, 121 abut against each other, and a folded position, as shown in FIG. 6, where the upper edge of the forward abutting wall 121 is remote from the upper edge of the rearward abutting wall 111, and where the front and rear wheels 4, 5 are juxtaposed in the transverse direction. Preferably, as shown in FIG. 7, the front shank segment 11a has a protrusion 113 extending from the rearward abutting wall 111, and the rear shank segment 12a has a groove 123 which is formed in the forward abutting wall 121, and which is configured to mate with the protrusion 113 such that when the rear shank segment 12a is in the unfolded position, the protrusion 113 and the groove 123 are fully engaged with each other so as to prevent movement of the rear shank segment 12a in the transverse direction.

The rear frame 12 further includes a seat tube 124 which extends uprightly and which is disposed proximate to the rear shank segment 12a, a rear fork 125 which extends rearwardly from the seat tube 124 to connect with the rear wheel axle 12b, and a seat post 126 which is disposed in an upper portion of the seat tube 124.

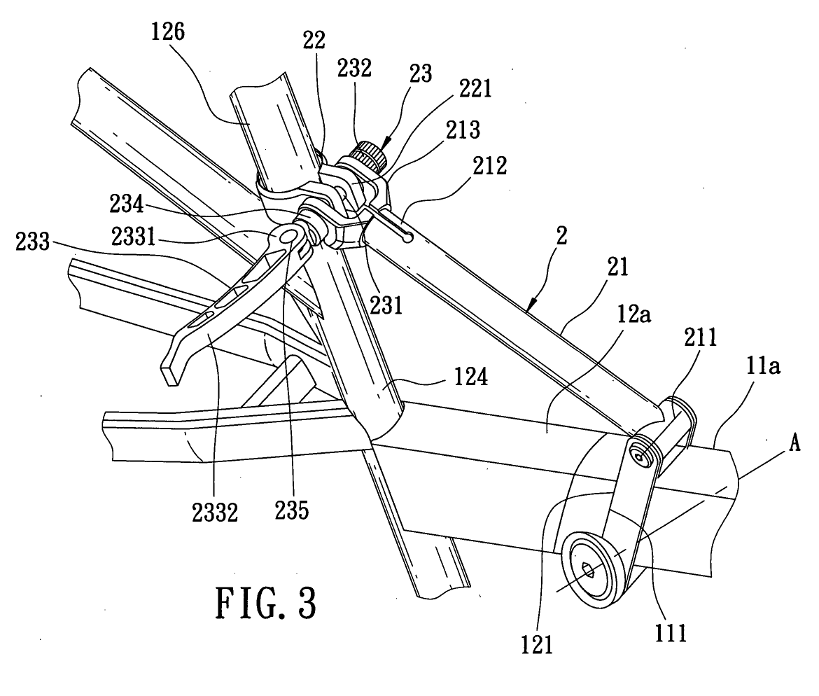

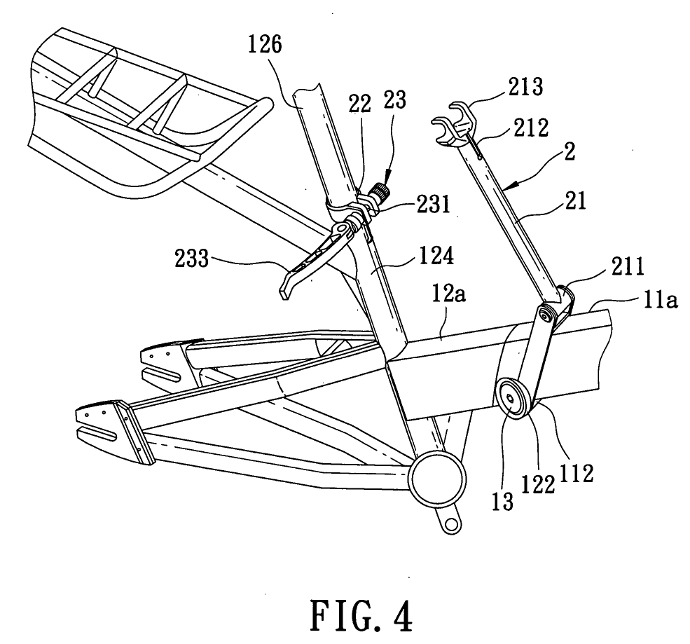

With reference to FIGS. 3 and 4, the bracing device 2 includes a bracing lever 21, an anchored mount 22, and a tightening member 23.

The bracing lever 21 has a pivot end 211 which is pivotally mounted on the front shank segment 11a about a rotating axis parallel to the rear wheel axis of the rear wheel axle 12b, a retaining end 212 which is configured to be operable to turn about the rotating axis, and left and right lugs 213 which are disposed on the retaining end 212.

The anchored mount 22 is in the form of a C-shaped clamp which has an open ring portion fitted around the seat tube 124 and terminating at two edges, and two jaws 221 which extend from the edges of the ring portion away from the rear wheel axle 12b and which are spaced apart from each other to define a gap therebetween. The jaws 221 respectively have two abutment surfaces opposite to each other in the transverse direction, and two through holes extending through the abutment surfaces. The left and right lugs 213 of the bracing lever 21 are configured to flank the abutment surfaces of the jaws 221 when the retaining end 212 is turned to a retained position.

The tightening member 23 defines a tightening axis in the transverse direction, and includes an enlarged head 232 which is configured to abut against the right lug 213, an intermediate segment 231 which extends from the enlarged head 232 in the transverse direction, and which is configured to pass through the through holes in the jaws 221 and the left and right lugs 213, a pulled segment which extends from the intermediate segment 231 away from the enlarged head 232 and which terminates at a pivoted end 235, a spacer 234 which is sleeved on the pulled segment and which has depressed and pressing surfaces opposite to each other in the transverse direction, and an actuating lever 233. The actuating lever 233 has a pivoting end 2331 and a lever arm 2332. The pivoting end 2331 is pivotally mounted on the pivoted end 235 about a pivotal axis that is radial to the tightening axis, and has a cam surface which extends angularly about the pivotal axis and which has tightening and loosening areas angularly displaced from each other. Specifically, when the tightening area is brought to abut against the depressed surface of the spacer 234, the pulled segment is forced to move away from the left lug 213 so as to enable the enlarged head 232 and the spacer 234 to cooperate with the jaws 221 to clamp the left and right lugs 213, and to enable the jaws 221 to move toward each other to narrow the gap so as to firmly secure the ring portion of the anchored mount 22 on the seat tube 124. On the other hand, when the loosening area is brought to displace towards the depressed surface of the spacer 234, the pulled segment is moved toward the left lug 213 so as to loosen engagement between the spacer 234 and the left lug 213. The lever arm 2332 extends from the pivoting end 2331, and is manually operated to turn the pivoting end 2331 about the pivotal axis so as to bring one of the tightening and loosening areas to abut against the depressed surface.

Therefore, the retaining end 212 of the bracing lever 21 is operable to turn about the rotating axis between the retained position, where the left and right lugs 213 are prevented from disengaging from the tightening member 23 when the rear shank segment 12a is in the unfolded position and when the tightening area is brought to abut against the depressed surface of the spacer 234, thereby preventing turning of the rear shank segment 12a relative to the front shank segment 11a about the pivot axis (A), and a releasing position, as shown in FIG. 4, where the loosening area is brought to abut against the depressed surface of the spacer 234 to permit disengagement of the left and right lugs 213 from the tightening member 23, thereby permitting turning of the rear shank segment 12a relative to the front shank segment 11a about the pivot axis (A).

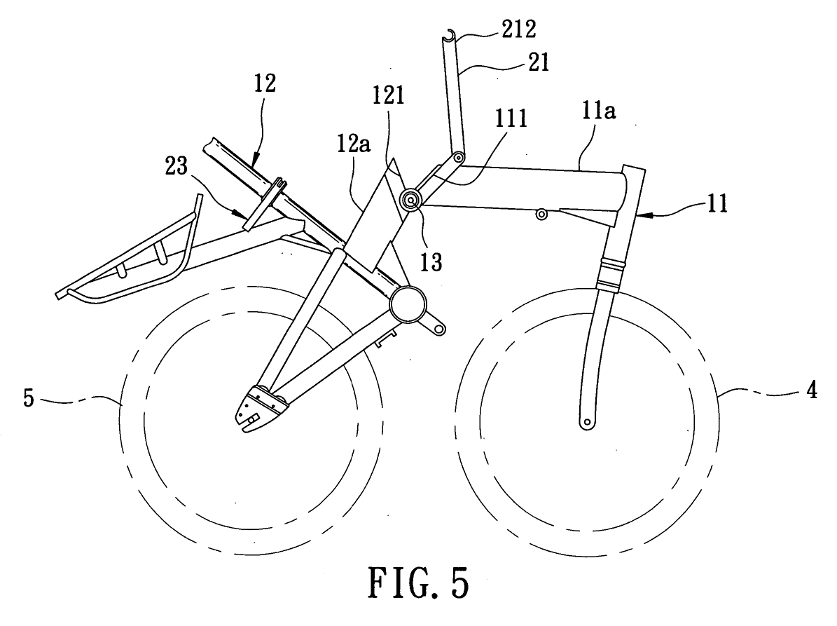

When it is desired to fold the foldable bicycle of this invention, the retaining end 212 of the bracing lever 21 is operated to turn to the releasing position, and is pulled upwardly such that the front and rear frames 11, 12 turn toward each other about the pivot axis (A) of the journal pin 13 by virtue of the gravity thereof, as shown in FIGS. 5 and 6, until the front and rear wheels 4, 5 are juxtaposed in the transverse direction, as shown in FIG. 7. Since the pivot axis (A) is not parallel to the rear wheel axis, a distance (D) exists between the front and rear wheels 4, 5. Therefore, the rear wheel 5 will not interfere with the front wheel 4 when turning about the pivot axis (A), thereby make the folding operation convenient and smooth.

Moreover, referring to FIGS. 1, 2 and 7, the positioning device 3 includes a latch hole 321 which is formed in the rear frame 12 and rearwardly of the forward abutting wall 121, a sleeve 311 which is disposed on the front frame 11, and a latch 312 which movably extends through the sleeve 311 and forwardly of the rearward abutting wall 111 and which has an operated portion 313 that is operable to be inserted into the latch hole 321 when the rear shank segment 12a is in the folded position so as to position the rear shank segment 12a firmly in the folded position.

It is noted that because the journal pin 13 extends horizontally, stress concentration thereon can be prevented.

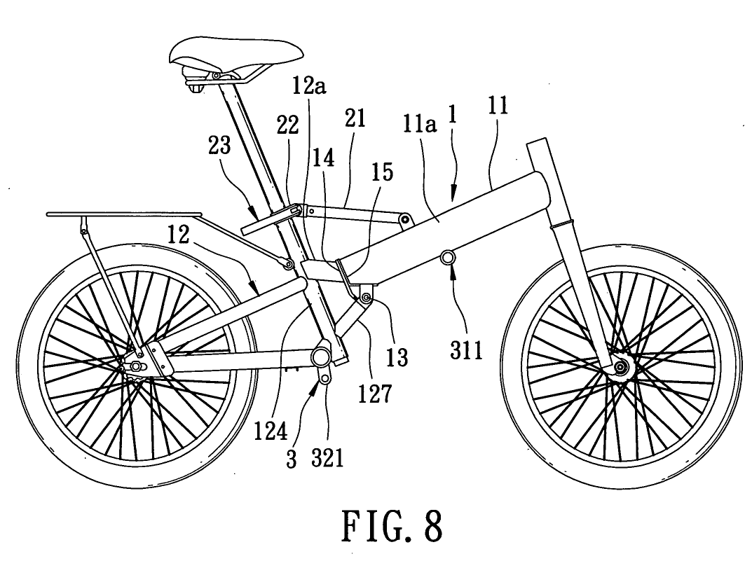

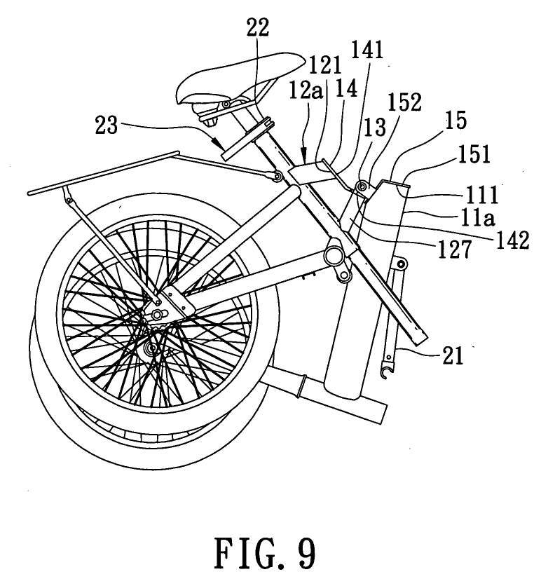

Referring to FIGS. 8 and 9, the second preferred embodiment of a foldable bicycle according to this invention is shown to be similar to the previous embodiment in construction. In this embodiment, the bicycle frame unit 1 further has two end connecting plates 14, 15 which respectively have connecting portions 141, 151 secured to the forward and rearward abutting walls 121, 111. The end connecting plates 14, 15 further have a journal 142 and a pair of lug portions 152, respectively, such that the journal pin 13 extends through the lug portions 152 and the journal 142 along the pivot axis. The rear frame 12 has a stem 127 extending forwardly from a lower portion of the seat tube 124 to connect with the journal 142.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A foldable bicycle comprising:
front and rear frames respectively having front and rear shank segments which extend towards each other along a longitudinal axis in an unfolded position, and which respectively terminate at rearward and forward abutting walls that respectively have upper edges extending in a transverse direction relative to the longitudinal axis;
front and rear wheel axles which are respectively mounted to said front and rear frames, and which are adapted for mounting of front and rear wheels, said rear wheel axle extending along a rear wheel axis which is oriented in the transverse direction;
a journal pin which is disposed to interconnect said front and rear frames, which is disposed below said upper edges of said rearward and forward abutting walls, and which extends along a pivot axis that is non-parallel to the rear wheel axis such that said rear shank segment is turnable relative to said front shank segment about the pivot axis between the unfolded position, where said rearward and forward abutting walls abut against each other, and a folded position, where said upper edge of said forward abutting wall is remote from said upper edge of said rearward abutting wall, and where the front and rear wheels are adapted to be juxtaposed in the transverse direction; and
a bracing lever having a pivot end which is pivotally mounted on one of said front and rear frames about a rotating axis parallel to the rear wheel axis, and a retaining end which is configured to be operable to turn about the rotating axis between a retained position, where said retaining end is prevented from disengaging from the other one of said front and rear frames when said rear shank segment is in the unfolded position so as to prevent turning of said rear shank segment relative to said front shank segment about the pivot axis, and a releasing position, where said retaining end is disengaged from said other one of said front and rear frames so as to permit turning of said rear shank segment relative to said front shank segment about the pivot axis.

2. The foldable bicycle of claim 1, further comprising
an anchored mount which is mounted on said rear frame and which extends away from said rear wheel axle, said anchored mount having two abutment surfaces opposite to each other in the transverse direction, and a through hole extending through said abutment surfaces;
left and right lugs which are disposed on said retaining end and which are configured to flank said abutment surfaces when said retaining end is in the retained position; and
a tightening member defining a tightening axis in the transverse direction, and including
an enlarged head which is configured to abut against said right lug,
an intermediate segment which extends from said enlarged head in the transverse direction, and which is configured to pass through said through hole and said left and right lugs,
a pulled segment which extends from said intermediate segment away from said enlarged head and which terminates at a pivoted end,
a spacer which is sleeved on said pulled segment and which has depressed and pressing surfaces opposite to each other in the transverse direction, and
an actuating lever having
a pivoting end which is pivotally mounted on said pivoted end about a pivotal axis that is radial to the tightening axis, said pivoting end having a cam surface which extends angularly about the pivotal axis and which has tightening and loosening areas angularly displaced from each other such that, when said tightening area is brought to abut against said depressed surface of said spacer, said pulled segment is forced to move away from said left lug so as to enable said enlarged head and said spacer to cooperate with said anchored mount to clamp said left and right lugs, and such that, when said loosening area is brought to displace towards said depressed surface, said pulled segment is moved toward said left lug so as to loosen engagement between said spacer and said left lug, and
a lever arm which extends from said pivoting end and which is manually operated to turn said pivoting end about the pivotal axis so as to bring one of said tightening and loosening areas to abut against said depressed surface.

3. The foldable bicycle of claim 2, wherein said rear frame includes a seat tube extending uprightly and disposed proximate to said rear shank segment, said anchored mount being in form of a C-shaped clamp which has an open ring portion fitted around said seat tube and terminating at two edges, and two jaws which extend from said edges of said ring portion and which are spaced apart from each other to define a gap therebetween, said abutment surfaces being formed on said jaws, respectively, such that said jaws are moved toward each other when said lever arm of said actuating lever is turned to bring said tightening area to displace toward said depressed surface to narrow said gap so as to firmly secure said ring portion on said seat tube.

4. The foldable bicycle of claim 1, wherein said rearward and forward abutting walls share an inclined plane that is inclined relative to the longitudinal axis when said rear shank segment is in the unfolded position, the pivot axis extending along the inclined plane.

5. The foldable bicycle of claim 4, wherein one of said front and rear shank segments has a protrusion extending from one of said rearward and forward abutting walls, and the other one of said front and rear shank segments has a groove which is formed in the other one of said rearward and forward abutting walls, and which is configured to mate with said protrusion such that when said rear shank segment is in the unfolded position, said protrusion and said groove are fully engaged with each other so as to prevent movement of said rear shank segment in the transverse direction.

6. The foldable bicycle of claim 4, wherein said rear shank segment has a pair of lug portions which are disposed below said upper edge and which are spaced apart from each other along the pivot axis, said front shank segment having a journal which is disposed between said lug portions, said journal pin extending through said lug portions and said journal.

7. The foldable bicycle of claim 1, further comprising a positioning device which is disposed to position said rear frame relative to said front frame when said rear shank segment is in the folded position.

8. The foldable bicycle of claim 7, wherein said positioning device includes a latch hole which is formed in said rear frame and rearwardly of said forward abutting wall, and a latch which is movably mounted on said front frame and forwardly of said rearward abutting wall and which is operable to be inserted into said latch hole when said rear shank segment is in the folded position.
